(19) United States
(12) Patent Application Publication
(10) Pub. No.: US 2011/0167557 A1
(43) Pub. Date: Jul. 14, 2011

(54) Bronze outlet pipe and making process thereof

(76) Inventor: Xiqiao Tan, Shen Zen (CN)

(21) Appl. No.: 12/686,351

(22) Filed: Jan. 12, 2010

(51) Int. Cl. E03C 1/04; B21D 51/42; B21D 53/00; B23P 15/00; B21D 17/00; B21D 26/02

(52) U.S. Cl. 4/675; 137/356; 4/567; 4/692; 29/890.141; 137/801; 72/370.23; 72/370.21; 72/54

(57) ABSTRACT

A bronze outlet pipe and making process thereof comprises the steps of: a. fluid inflation forming; b. working an outer wall of the tube member; c. working a first and a second connectors; d. working an arcuate leadless brass tube; e. selectively welding the first inlet with the orifice or welding the first outlet with the mouth together; f. welding the first connector and the tube member together; g. selectively welding the first connector or the second connector with the first opening of the first inlet together, or welding the orifice of the first connector or the mouth of the second connector with the first inlet of the tube member or the first outlet of the tube member together; h. surface treating; wherein the tube member and plural welding portions are surface treated to finish the bronze outlet pipe.

### BACKGROUND OF THE INVENTION

1. Field of the Invention

The present invention relates to a bronze outlet pipe and making process thereof that can obtain light weight, and during the making process, pollution will not occur.

2. Description of the Prior Art

Conventional outlet pipe includes a tube member made by casting and fluid inflation forming, however the casting method will produce the finished product with rough surface, and cause a pollution.

As shown in FIG. 1, when an outlet pipe 10 is fluid inflation formed, the tube member 11 is formed on the outlet pipe 10, and one end of the tube member 11 proximate to an inlet and includes a partition 12 welded therein so that a space 13 is spaced between the partition 12 and one side of the inlet end, and the tube member 11 includes a bore 14 formed on a top end thereof to communicate with the space 13 so that a pulling area 15 is comprised of the bore 14 and the space 13 to insert a pulling shaft, and then a first and a second connectors 16, 17 are welded to the outlet and the inlet ends of tube member 11 to finish the outlet pipe 10.

However, between a top end of the partition 12 and the tube member 11 are defined a plurality of welding points, therefore the welding process is difficult and complex, and a water leak occurs easily. Also, the high temperature generating form the welding process will make the tube member 11 deformable, for example, the wall thickness of the tube member 11 is about 1.5 mm before the fluid inflation forming process, but after the tube member 11 is fluid inflation formed, its wall thickness will lower to 0.7-1.5 mm, and the welding surface is rough to affect appearance. In addition, a tunnel 18 of the tube member 11 is washed to eliminate lead substances, having high production cost.

The present invention has arisen to mitigate and/or obviate the afore-described disadvantages.

### SUMMARY OF THE INVENTION

The primary object of the present invention is to provide a bronze outlet pipe and making process thereof which is capable of overcoming the shortcomings of the conventional outlet pipe and making process thereof.

A making process of bronze outlet pipe in accordance with a preferred embodiment of the present invention comprises:

a. fluid inflation forming, wherein a tube member is made of cooper and formed by fluid inflating method, and includes a first inlet and a first outlet formed on two ends thereof respectively;

b. working an outer wall of the tube member proximate to the first inlet to form an intake on the outer wall of the tube member;

c. working a first connector and a second connector to form an orifice and an aperture on the first connector and to form a mouth on the second connector;

d. working an arcuate leadless brass tube to form a tunnel defined in the leadless brass tube, and to form a second inlet and a second outlet on two ends of the leadless brass tube respectively;

wherein the steps of b, c, and d are processed individually without following a certain order;

e. selectively welding the first inlet of the tube member with the orifice of the first connector or welding the first outlet of the tube member with the mouth of the second connector together;

f. welding the first connector and the tube member together, wherein one end of the leadless brass tube is inserted to the tube member, and the first connector or the second connector of one welded end of the leadless brass tube is welded with a first opening of the first inlet of the tube member or a second opening of the first outlet thereof;

g. selectively welding the first connector or the second connector with the first opening of the first inlet of the tube member together, or welding the orifice of the first connector or the mouth of the second connector with the first inlet of the tube member or the first outlet of the tube member together;

h. surface treating; wherein the tube member and a plurality of welding portions are surface treated to finish the bronze outlet pipe;

wherein the steps of surface treating include an acid washing to eliminate oily substances and include a surface polishing;

wherein before two ends of the leadless brass tube are welded together, the second inlet and the orifice of the first connector are welded together selectively;

wherein before the second connector is welded, it is welded with the second opening of the first outlet of the tube member selectively;

wherein the leadless brass tube is made of red copper;

wherein the first and the second connectors are made of bronze bars individually.

A bronze outlet pipe made by the making process in accordance with a preferred embodiment of the present invention comprises:

the tube member fluid inflated to form an integrally arc shape, and including the channel disposed therein, the channel including the first inlet and the first outlet formed on two ends thereof respectively, and the tube member including the intake mounted on an upper wall thereof relative to the first opening;

the first connector including the orifice and the aperture formed thereon, the first connector allowing to be engaged and welded with the first opening of the first inlet of the tube member, and the aperture being in relation to the intake of the tube member;

the second connector including the mouth and engaged and welded with the second opening of the first outlet of the tube member;

the leadless brass tube made of bronze material and formed in an arc shape, and including the tunnel formed therein, and including the second inlet and the second outlet formed on the two ends thereof respectively; the second inlet being engaged and welded with the orifice of the first connector, and the second outlet being engaged and welded with the mouth of the second connector;

wherein the first connector includes a first groove connected to a bottom end thereof, and the first groove includes a first cavity fixed on a central portion of a bottom wall thereof to define the orifice; after the second inlet of the leadless brass tube is engaged and welded with the orifice, a bottom rim of the second inlet flushes with the bottom wall of the first groove;

wherein the second connector includes a second groove arranged to a bottom end thereof, and the second groove includes a second cavity fixed on a central portion of a bottom wall thereof to define the mouth; after the second outlet is engaged and welded with the mouth, a bottom rim of the second outlet flushes with the bottom wall of the second groove;

wherein the first and the second connectors are made of bronze material.

### BRIEF DESCRIPTION OF THE DRAWINGS

FIG. 1 is a cross sectional view showing the assembly of a conventional outlet pipe;

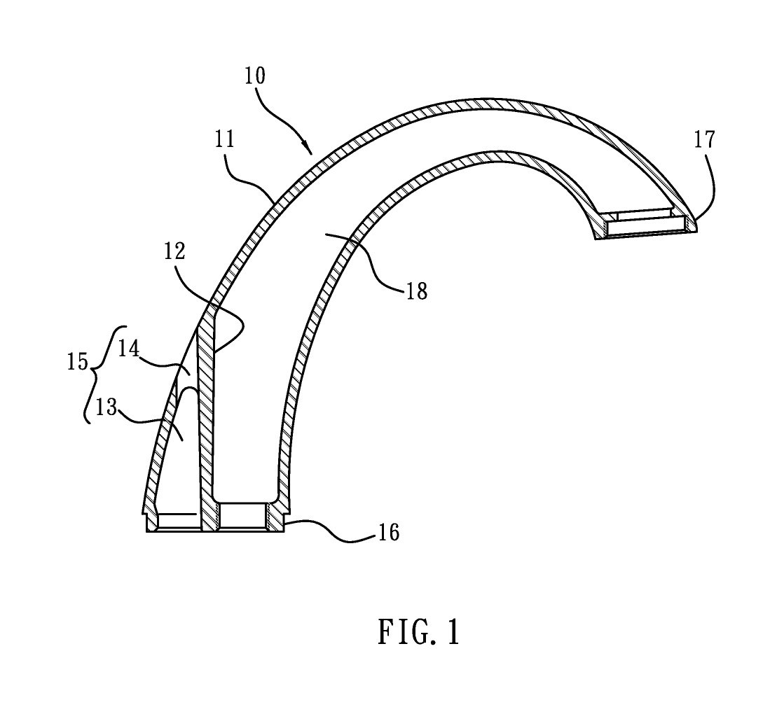

FIG. 2 is a flow chart showing the making process of a bronze outlet pipe in accordance with a preferred embodiment of the present invention;

FIG. 3 is a perspective view showing the exploded components of the bronze outlet pipe in accordance with the preferred embodiment of the present invention;

FIG. 4 is a perspective view showing an orifice of a first connector being assembled to a second inlet of a leadless brass tube in accordance with the preferred embodiment of the present invention;

FIG. 5 is a perspective view showing the leadless brass tube being inserted to a first inlet of a tube member in accordance with the preferred embodiment of the present invention;

FIG. 6 is a perspective view showing a second connector being assembled to the leadless brass tube in accordance with the preferred embodiment of the present invention;

FIG. 7 is a perspective view showing the assembly of the bronze outlet pipe in accordance with the preferred embodiment of the present invention;

FIG. 8 is a cross sectional view showing the assembly of the bronze outlet pipe in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

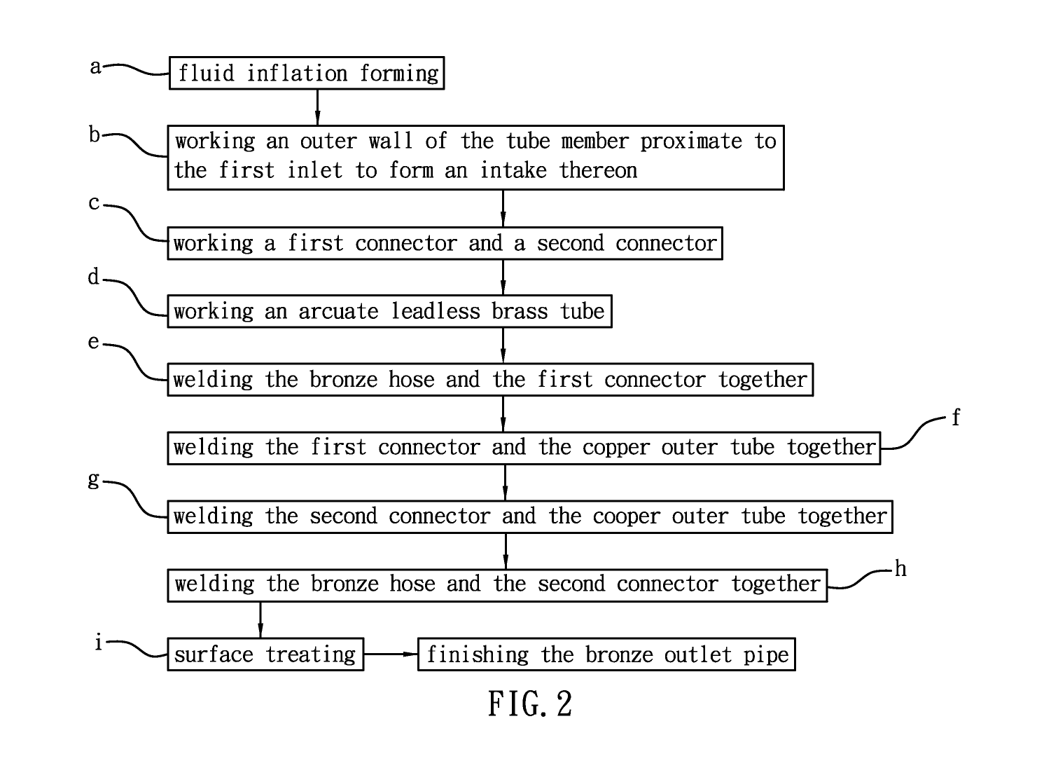

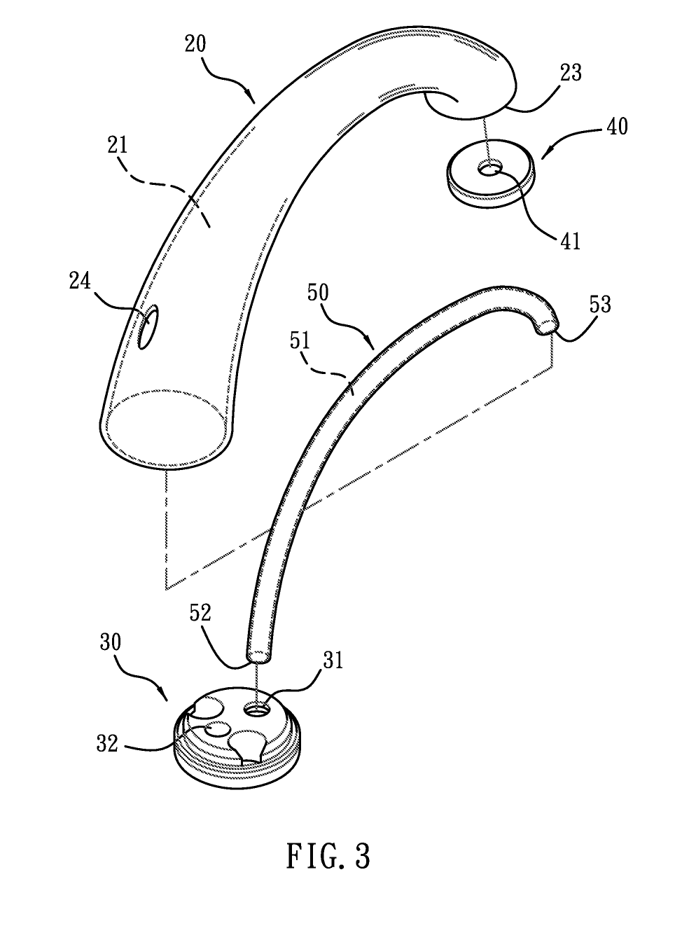

Referring to FIGS. 2 and 3, a making process of making bronze outlet pipe according to a preferred embodiment of the present invention comprises the steps of:

a. fluid inflation forming, wherein a tube member 20 is made of cooper and formed by fluid inflating method, and includes a channel 21 formed therein, and includes a first inlet 22 and a first outlet 23 formed on two ends thereof respectively, the first inlet 22 and the first outlet 23 include a first and a second openings 221, 231 defined thereon individually;

b. working an outer wall of the tube member 20 proximate to the first inlet 22 to form an intake 24 on the outer wall of the tube member 20;

c. forming a first connector 30 and a second connector 40 from a bronze bar, and then working the first connector 30 to form an orifice 31 and an aperture 32 thereon, wherein the orifice 31 includes a first groove 311 connected to a bottom end thereof; and working the second connector 40 to form a mouth 41 thereon, wherein the mouth 41 includes a second groove 411 coupled to a bottom end thereof;

d. working an arcuate leadless brass tube 50 with a predetermined length mechanically to define a tunnel 51 therein to supply water, and to form a second inlet 52 and a second outlet 53 on two ends thereof respectively, wherein the leadless brass tube 50 is made of red copper;

wherein the steps of b, c, and d are processed individually without following a certain order;

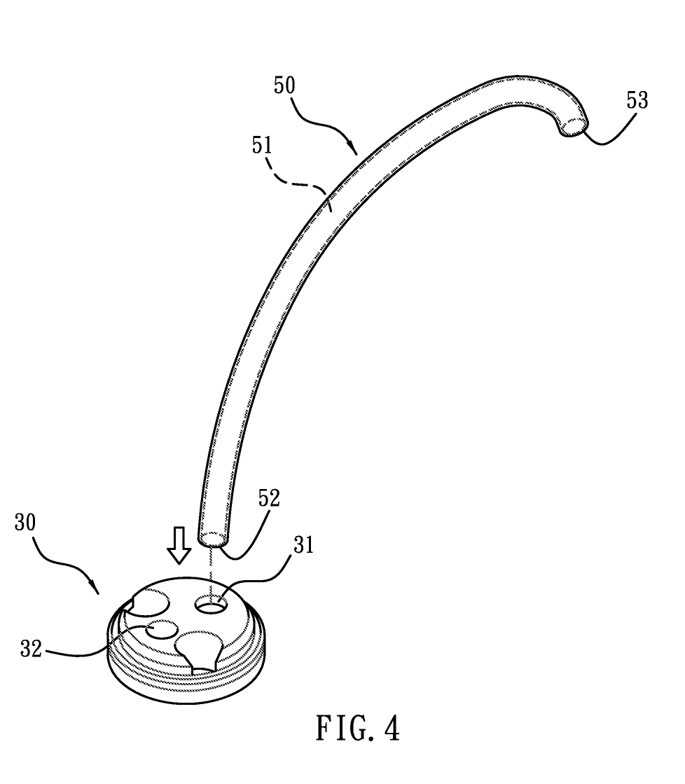

e. welding the leadless brass tube 50 and the first connector 30 together, wherein the second inlet 52 of the leadless brass tube 50 is engaged with the orifice 31 of the first connector 30, and then the second inlet 52 and the orifice 31 are welded together as shown in FIG. 4;

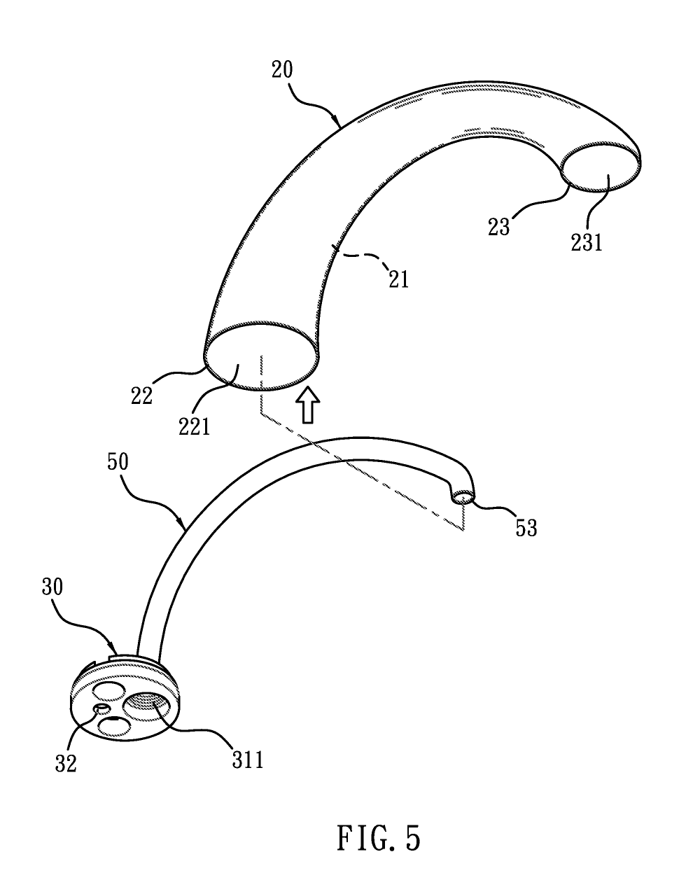

f. welding the first connector 30 and the tube member 20 together, wherein one end of the leadless brass tube 50 with the second outlet 53 is inserted to the channel 21 from one end of the tube member 20 with the first inlet 22 as illustrated in FIG. 5, the first connector 30 and the first opening 221 of the first inlet 22 of the tube member 20 are engaged and welded together;

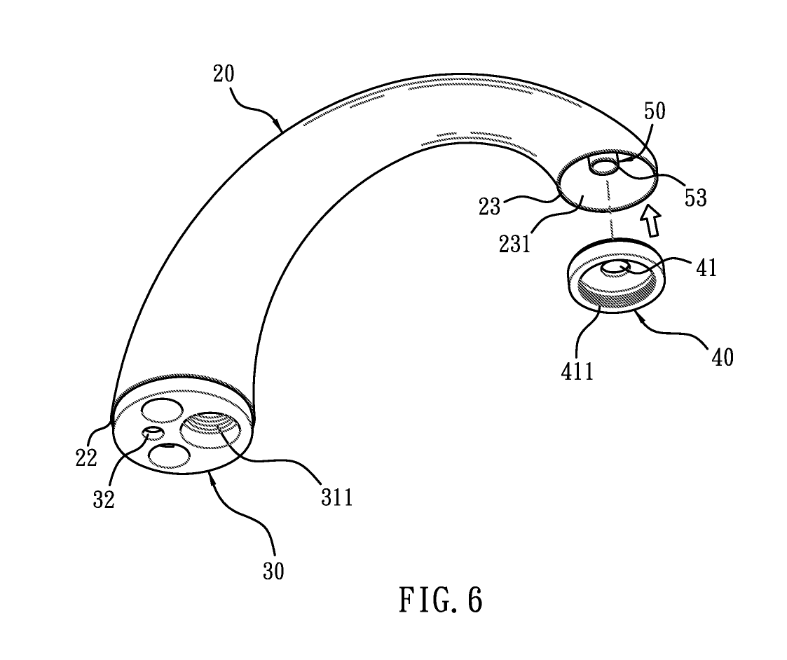

g. welding the second connector 40 and the tube member 20 together, wherein the second connector 40 is engaged with the second opening 231 of the first outlet 23 of the tube member 20, and then the second connector 40 and the second opening 231 are welded together as illustrated in FIG. 6;

h. welding the leadless brass tube 50 and the second connector 40 together, wherein the second outlet 53 of the leadless brass tube 50 is engaged with the mouth 41 of the second connector 40, and then the second outlet 53 and the mouth 41 are welded together;

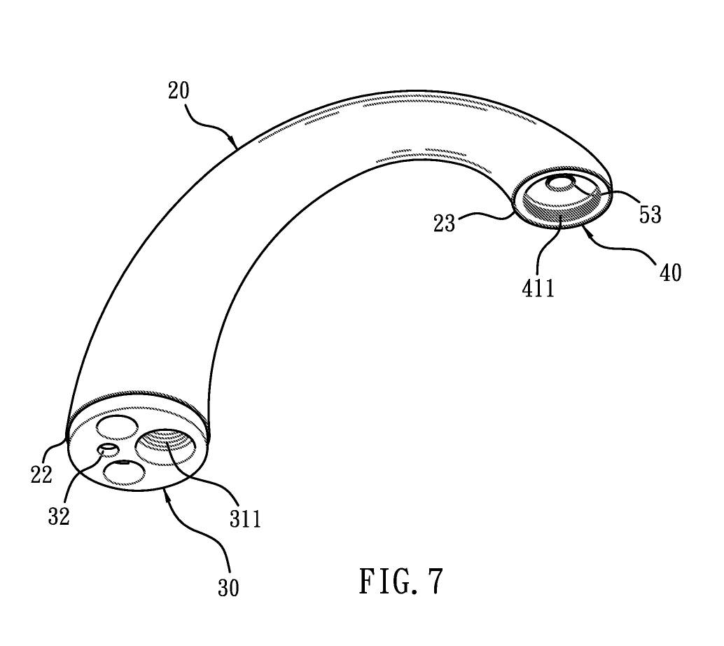

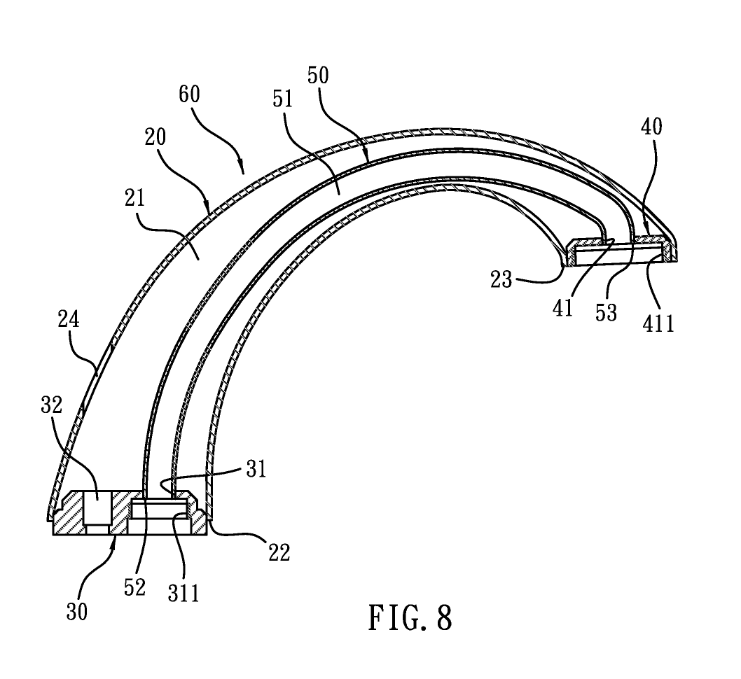

i. surface treating; wherein the tube member 20 and a plurality of welding portions in the steps of e, f, g, and h are surface treated, the steps of surface treating include an acid washing to eliminate oily substances and include a surface polishing to finish the bronze outlet pipe as shown in FIGS. 7 and 8. Referring to FIGS. 2 and 3, a making process of the bronze outlet pipe according to the preferred embodiment of the present invention comprises: before welding two ends of the leadless brass tube 50 together (e.g., before the step of e), the second inlet 52 and the orifice 31 of the first connector 30 are welded together, and before the second connector 40 is welded (e.g., step of g), the second connector 40 is welded with the second opening 231 of the first outlet 23 of the tube member 20. However, other methods, such as before the step of e, the second outlet 53 of the leadless brass tube 50 is welded with the mouth 41 of the second connector 40, and then another end of the leadless brass tube 50 with the second inlet 52 is inserted to the channel 21 from another end of the tube member 20 with the first outlet 23, and then the following methods are selected:

first, the first connector 30 is engaged with the first opening 221 of the first inlet 22 of the tube member 20, and then is welded with the first opening 221 of the first inlet 22 of the tube member 20, thereafter the second inlet 52 of the leadless brass tube 50 and the orifice 31 of the first connector 30 are engaged and welded together to finish the outlet pipe 60;

second, the orifice 31 of the first connector 30 is engaged with the second inlet 52 of the leadless brass tube 50 to be welded together, and then the first connector 30 is fitted to the first opening 221 of the first inlet 22 of the tube member 20 to be welded together, thus finishing the outlet pipe 60 as well.

As illustrated in FIGS. 2, 7, and 8, the outlet pipe 60 includes the tube member 20, the first connector 30, the second connector 40, and the leadless brass tube 50, wherein:

the tube member 20 is fluid inflated to form an integrally arc shape, and includes the channel 21 disposed therein. The channel 21 includes the first inlet 22 and the first outlet 23 formed on two ends thereof respectively, and the tube member 20 includes the intake 24 mounted on an upper wall thereof relative to the first opening 221.

The first connector 30 is made of the bronze bar, and includes the orifice 31 and the aperture 32 formed thereon. The first connector 30 allows to be engaged and welded with the first opening 221 of the first inlet 22 of the tube member 20, and the aperture 32 is in relation to the intake 24 of the tube member 20. The first connector 30 includes the first groove 311 connected to the bottom end thereof, and the first groove 311 includes a first cavity fixed on a central portion of a bottom wall thereof to define the orifice 31.

The second connector 40 is made of a bronze bar, and includes the mouth 41, and is engaged and welded with the second opening 231 of the first outlet 23 of the tube member 20. The second connector 40 includes the second groove 411 arranged to a bottom end thereof, and the second groove 411 includes a second cavity fixed on a central portion of a bottom wall thereof to define the mouth 41.

The leadless brass tube 50 is made of bronze material and formed in an arc shape, and includes the tunnel 51 formed therein, and includes the second inlet 52 and the second outlet 53 formed on the two ends thereof respectively; the second inlet 52 is engaged and welded with the orifice 31 of the first connector 30, and the second outlet 53 is engaged and welded with the mouth 41 of the second connector 40. After the second inlet 52 of the leadless brass tube 50 is engaged and welded with the orifice 31, a bottom rim of the second inlet 52 flushes with the bottom wall of the first groove 311, and after the second outlet 53 is engaged and welded with the mouth 41, a bottom rim of the second outlet 53 flushes with the bottom wall of the second groove 411.

Therefore, the tube member 20 of the present invention is made by fluid inflating to obtain light weight, and during the making process, a pollution will not occur. Besides, a difficult partition welding is not used in the making process but a general welding is applied to lower welding difficulty and failure, and to enhance production efficiency, product yields, and aesthetics appearance, and to simplify manufacture process.

Because the tunnel 51 is installed in the leadless brass tube 50 of the tube member 20, and the leadless brass tube 50 is made of bronze material, water flowing in the tunnel 51 is not polluted by lead. Also, the first and the second connectors 30, 40 are made of bronze material to prevent from lead pollution.

Furthermore, the leadless brass tube 50 is fixed in the tunnel 51 to weld the tunnel 51 with the first and the second connectors 30 and 40, therefore the connecting portions are reinforced to prevent water from leak at high pressure.

While we have shown and described various embodiments in accordance with the present invention, it is clear to those skilled in the art that further embodiments may be made without departing from the scope of the present invention.

What is claimed is:

1. A making process of bronze outlet pipe comprising the steps of:
a. fluid inflation forming, wherein a tube member is made of cooper and formed by fluid inflating method, and includes a first inlet and a first outlet formed on two ends thereof respectively;
b. working an outer wall of the tube member proximate to the first inlet to form an intake on the outer wall of the tube member;
c. working a first connector and a second connector to form an orifice and an aperture on the first connector and to form a mouth on the second connector;
d. working an arcuate leadless brass tube to form a tunnel defined in the leadless brass tube, and to form a second inlet and a second outlet on two ends of the leadless brass tube respectively;
wherein the steps of b, c, and d are processed individually without following a certain order;
e. selectively welding the first inlet of the tube member with the orifice of the first connector or welding the first outlet of the tube member with the mouth of the second connector together;
f. welding the first connector and the tube member together, wherein one end of the leadless brass tube is inserted to the tube member, and the first connector or the second connector of one welded end of the leadless brass tube is welded with a first opening of the first inlet of the tube member or a second opening of the first outlet thereof;
g. selectively welding the first connector or the second connector with the first opening of the first inlet of the tube member together, or welding the orifice of the first connector or the mouth of the second connector with the first inlet of the tube member or the first outlet of the tube member together;
h. surface treating; wherein the tube member and a plurality of welding portions are surface treated to finish the bronze outlet pipe.

2. The making process of bronze outlet pipe as claimed in claim 1, wherein the steps of surface treating include an acid washing to eliminate oily substances and include a surface polishing.

3. The making process of bronze outlet pipe as claimed in claim 1, wherein before two ends of the leadless brass tube are welded together, the second inlet and the orifice of the first connector are welded together selectively.

4. The making process of bronze outlet pipe as claimed in claim 3, wherein before the second connector is welded, it is welded with the second opening of the first outlet of the tube member selectively.

5. The making process of bronze outlet pipe as claimed in claim 1, wherein the leadless brass tube is made of red copper.

6. The making process of bronze outlet pipe as claimed in claim 1, wherein the first and the second connectors are made of bronze bars individually.

7. A bronze outlet pipe made by the making process as claimed in claim 1 comprising:
the tube member fluid inflated to form an integrally arc shape, and including the channel disposed therein, the channel including the first inlet and the first outlet formed on two ends thereof respectively, and the tube member including the intake mounted on an upper wall thereof relative to the first opening;
the first connector including the orifice and the aperture formed thereon, the first connector allowing to be engaged and welded with the first opening of the first inlet of the tube member, and the aperture being in relation to the intake of the tube member;
the second connector including the mouth and engaged and welded with the second opening of the first outlet of the tube member;
the leadless brass tube made of bronze material and formed in an arc shape, and including the tunnel formed therein, and including the second inlet and the second outlet formed on the two ends thereof respectively; the second inlet being engaged and welded with the orifice of the first connector, and the second outlet being engaged and welded with the mouth of the second connector.

8. The bronze outlet pipe as claimed in claim 7, wherein the first connector includes a first groove connected to a bottom end thereof, and the first groove includes a first cavity fixed on a central portion of a bottom wall thereof to define the orifice; after the second inlet of the leadless brass tube is engaged and welded with the orifice, a bottom rim of the second inlet flushes with the bottom wall of the first groove.

9. The bronze outlet pipe as claimed in claim 7, wherein the second connector includes a second groove arranged to a bottom end thereof, and the second groove includes a second cavity fixed on a central portion of a bottom wall thereof to define the mouth; after the second outlet is engaged and welded with the mouth, a bottom rim of the second outlet flushes with the bottom wall of the second groove.

10. The bronze outlet pipe as claimed in claim 7, wherein the first and the second connectors are made of bronze material.
